(19) United States
(12) Patent Application Publication
(10) Pub. No.: US 2025/0264836 A1
(43) Pub. Date: Aug. 21, 2025

(54) SHEET CHARACTERISTIC DETECTION APPARATUS, IMAGE FORMING SYSTEM, AND RECORDING MEDIUM

(71) Applicant: Konica Minolta, Inc., Tokyo (JP)

(72) Inventors: Hiroyuki Yoshikawa, Toyohashi-shi (JP); Junichi Masuda, Toyokawa-shi (JP); Satoshi Ogata, Tokyo (JP); Akimasa Ishikawa, Tokyo (JP)

(73) Assignee: Konica Minolta, Inc., Tokyo (JP)

(21) Appl. No.: 19/052,680

(22) Filed: Feb. 13, 2025

(30) Foreign Application Priority Data
Feb. 15, 2024 (JP) 2024-020984

(51) Int. Cl. G03G 15/00

(52) U.S. Cl. CPC G03G 15/5029; G03G 2215/00025; G03G 2215/00738; G03G 2215/00763; G03G 2215/00776

(57) ABSTRACT

A sheet characteristic detection apparatus includes a first characteristic detector that is arranged on a conveyance path of a sheet and detects first characteristic information corresponding to a first characteristic of the sheet, and a second characteristic detector that is arranged on the conveyance path and detects second characteristic information corresponding to a second characteristic of the sheet, in which, on the basis of a detection result of any one of the first characteristic detector and the second characteristic detector, the other characteristic detector is controlled.

### CROSS-REFERENCE TO RELATED APPLICATIONS

The entire disclosure of Japanese Patent Application No. 2024-020984 filed on Feb. 15, 2024 is incorporated herein by reference in its entirety.

### BACKGROUND OF THE INVENTION

### TECHNICAL FIELD

The present invention relates to a sheet characteristic detection apparatus, an image forming system, and a recording medium.

### DESCRIPTION OF RELATED ART

In an image forming apparatus that forms an image on a sheet and outputs the sheet, various conditions (image forming conditions) related to an image forming operation, a conveyance operation of a recording medium, and the like are appropriately adjusted according to characteristics of the sheet on which the image is to be formed, whereby the recording medium is stably conveyed, so that a high-quality image can be formed. There are various types of sheets to be used, and therefore, there is a technique (for example, JP 2023-084232A) in which an image forming apparatus is provided with sensors for measuring physical properties of a sheet, the physical properties of the sheet to be conveyed are specified from measurement results by the sensors, and thus condition setting is performed. The physical properties of the sheet include the moisture content, electric resistance, stiffness, and the like of the sheet.

### SUMMARY OF THE INVENTION

However, depending on characteristics of the sheet such as physical properties of the sheet, various problems may occur in measurement by the sensor. For example, in a case where the moisture content of the sheet is high, when a high voltage is applied to the sheet in order to measure the electric resistance of the sheet, the following problem may occur. Specifically, a leakage voltage is applied to an electric device in the apparatus via the sheet, and when the leakage voltage exceeds a withstand voltage, the electric device is damaged.

An object of the present invention is to provide a sheet characteristic detection apparatus, an image forming system, and a recording medium that can prevent a problem that occurs depending on characteristics of a sheet when the characteristics of the sheet are measured.

To achieve at least one of the abovementioned objects, according to an aspect of the present invention, a sheet characteristic detection apparatus reflecting one aspect of the present invention comprises:
a first characteristic detector that is arranged on a conveyance path of a sheet and detects first characteristic information corresponding to a first characteristic of the sheet; and
a second characteristic detector that is arranged on the conveyance path and detects second characteristic information corresponding to a second characteristic of the sheet,
in which, on a basis of a detection result of any one of the first characteristic detector and the second characteristic detector, the other characteristic detector is controlled.

To achieve at least one of the abovementioned objects, according to another aspect of the present invention, a recording medium reflecting one aspect of the present invention is a non-transitory recording medium storing a computer readable program for a computer of a sheet characteristic detection apparatus comprising:
a first characteristic detector that is arranged on a conveyance path of a sheet and detects first characteristic information corresponding to a first characteristic of the sheet; and
a second characteristic detector that is arranged on the conveyance path and detects second characteristic information corresponding to a second characteristic of the sheet,
the program causing a computer to perform:
controlling, on a basis of a detection result of any one of the first characteristic detector and the second characteristic detector, the other characteristic detector.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram illustrating an overall configuration of an image forming system of the present embodiment;

FIG. 2 is a diagram illustrating a detailed configuration of a sheet characteristic detection apparatus;

FIG. 3 is a diagram illustrating an example of a schematic configuration of a moisture content sensor;

FIG. 4A is a perspective view illustrating an example of a schematic configuration of a stiffness sensor;

FIG. 4B is a side view illustrating an example of a schematic configuration of the stiffness sensor;

FIG. 5 is a diagram illustrating an example of a schematic configuration of a resistance sensor;

FIG. 6 is a flowchart illustrating a control procedure for a detection control process;

FIG. 7 is a flowchart illustrating a control procedure for a detection control process of modification example 1;

FIG. 8 is a flowchart illustrating a control procedure for a detection control process of modification example 2;

FIG. 9 is a diagram illustrating a correspondence between a moisture content of a sheet and an applied voltage of modification example 2;

FIG. 10 is a diagram illustrating a correspondence between a moisture content of a sheet and the number of times of measurement with a resistance sensor of modification example 2;

FIG. 11 is a flowchart illustrating a control procedure for a detection control process of modification example 3;

FIG. 12A illustrates a schematic diagram of the sheet and a stiffness sensor before a first movement of a pressing member;

FIG. 12B illustrates a schematic diagram of the sheet and the stiffness sensor after the first movement of the pressing member;

FIG. 13A illustrates a schematic diagram of the sheet and the stiffness sensor before a second movement of the pressing member;

FIG. 13B is a schematic diagram of the sheet and the stiffness sensor after the second movement of the pressing member; and

FIG. 14 is a flowchart illustrating a control procedure for a detection control process of modification example 4.

### DETAILED DESCRIPTION

Hereinafter, embodiments of the present invention will be described with reference to the drawings. However, the scope of the invention is not limited to the disclosed embodiments or illustrated examples.

### 1. Configuration of Image Forming System

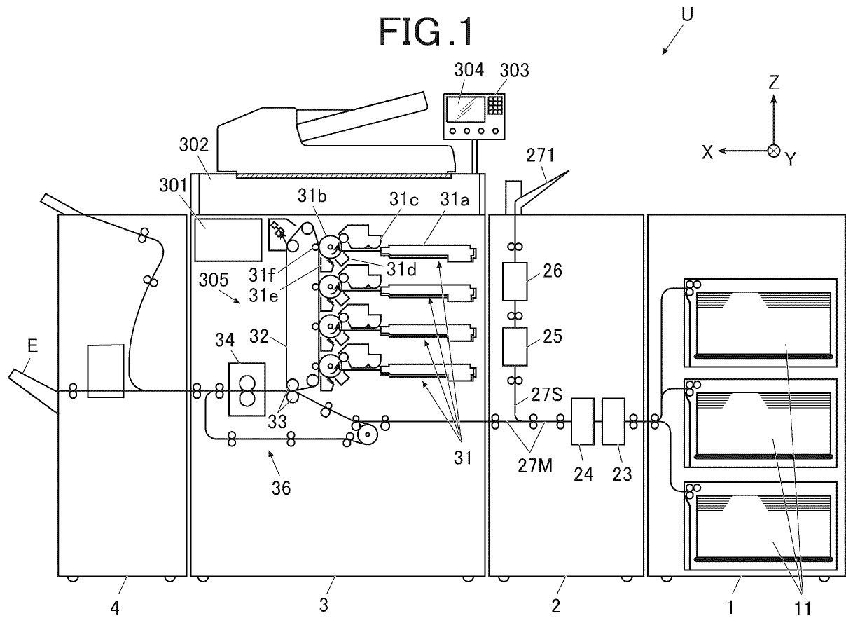

FIG. 1 is a diagram illustrates an overall configuration of an image forming system U according to the present embodiment.

The image forming system U includes a sheet feed apparatus 1, a sheet characteristic detection apparatus 2, an image forming apparatus 3, and a post-processing apparatus 4.

### Sheet Feed Apparatus

The sheet feed apparatus 1 includes a plurality of sheet feed trays 11. The sheet feed apparatus 1 sends a medium (sheet) on which an image is to be recorded one by one from any one selected and set from among of the sheet feed trays 11.

### Sheet Characteristic Detection Apparatus

The sheet characteristic detection apparatus 2 includes a plurality of sensors for measuring physical properties and the like of the sheet. The sheet characteristic detection apparatus 2 measures the sheet sent from the sheet feed apparatus 1 on its path with a plurality of sensors. The sheet characteristic detection apparatus 2 can specify the physical properties and the like (characteristic information) of the sheet on the basis of the measurement results. The characteristic information of the sheet may include characteristic values themselves of the sheet, or may include values indicating the characteristics such as a current and a voltage of a sensor corresponding to the characteristic values of the sheet. The sheet characteristic detection apparatus 2 may output the physical property values obtained by the measurement to the outside, for example, the image forming apparatus 3 as it is.

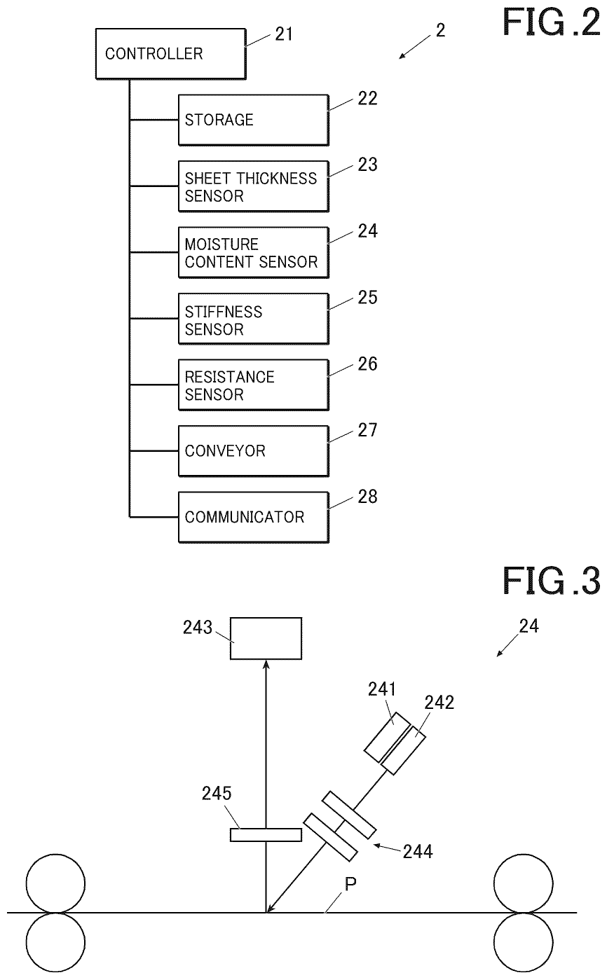

FIG. 2 is a block diagram of the sheet characteristic detection apparatus 2. The sheet characteristic detection apparatus 2 includes a controller 21 (hardware processor), a storage 22, a sheet thickness sensor 23, a moisture content sensor 24, a stiffness sensor 25, a resistance sensor 26, a conveyor 27, a communicator 28, and the like.

The controller 21 comprehensively controls the operation of the sheet characteristic detection apparatus 2. The controller 21 includes a central processing unit (CPU), a random access memory (RAM), and the like. The CPU controls a measurement operation with each of the sensors (the sheet thickness sensor 23, the moisture content sensor 24, the stiffness sensor 25, and the resistance sensor 26) and a conveyance operation of the sheet with the conveyor 27. The RAM temporarily stores a measurement result by each sensor and the like.

The storage 22 stores a control program of a measurement operation by each sensor, measurement setting data, and the like. The storage 22 includes a nonvolatile memory such as an HDD or a flash memory.

The conveyor 27 receives a sheet sent out from the sheet feed device 1 on the right side of FIG. 1, and sends the sheet to the image forming apparatus 3 from the left side of FIG. 1 along a first conveyance path 27M. A second conveyance path 27S branches from the middle of the first conveyance path 27S extending horizontally. A distal end of the second conveyance path 27S is connected to a purge tray 271.

On the first conveyance path 27M, the sheet thickness sensor 23 is located on the upstream side, and the moisture content sensor 24 is located on the downstream side.

On the second conveyance path 27S, the stiffness sensor 25 is located on the upstream side and the resistance sensor 26 is located on the downstream side.

The sheet thickness sensor 23 measures the sheet thickness of the sheet as the characteristic information of the sheet and outputs the measurement result.

The sheet thickness sensor 23 includes paired conveyance rollers in which at least one of the rollers is movable according to the thickness of the sheet that passes through a nip of the rollers, and a measurement unit that measures a distance between axes of the paired conveyance rollers. The measurement unit includes, for example, an actuator, an encoder, a light emitter, and a light receiver. An axial position of the movable driven roller is displaced according to the thickness of the sheet nipped by the paired conveyance rollers. The sheet thickness sensor 23 measures the sheet thickness of the sheet by measuring the height of the displaced axis.

The moisture content sensor 24 measures the characteristic information corresponding to the moisture content of the sheet and outputs the measurement result. In the present embodiment, the moisture content sensor that measures the moisture content of the sheet as the characteristic information of the sheet will be described as an example, but a moisture amount sensor that measures the amount of moisture contained in the sheet as the characteristic information of the sheet may be applied.

FIG. 3 is a schematic diagram illustrating a configuration of the moisture content sensor 24.

As illustrated in FIG. 3, the moisture content sensor 24 includes a first light emitter 241, a second light emitter 242, a light receiver 243, lenses 244 and 245, and the like.

The first light emitter 241 emits first near-infrared light (reference light) in a specific wavelength band toward a sheet P. Specific examples of the first light emitter 241 include a light emitting diode (LED). The first near-infrared light is light whose absorption percentage in the sheet P when being reflected off the sheet P is not dependent on the moisture content of the sheet P.

The light receiver 243 receives, via the lens 245, the first near-infrared light emitted from the first light emitter 241 and reflected off the sheet P via the lens 244.

Specific examples of the light receiver 243 include a charge-coupled device (CCD), and a complementary metal-oxide-semiconductor (CMOS) image sensor.

The second light emitter 242 emits second near-infrared light in a specific wavelength band toward the sheet P. Specific examples of the second light emitter 242 includes an LED. The second near-infrared light is light whose absorption percentage in the sheet P when being reflected off the sheet P varies according to the moisture content of the sheet P.

The light receiver 243 receives, via the lens 245, the second near-infrared light emitted from the second light emitter 242 and reflected off the sheet P via the lens 244.

The moisture content sensor 24 outputs the amount of the first near-infrared light and the amount of the second near-infrared light received by the light receiver 243 (characteristic information corresponding to the moisture content of the sheet) to the controller 21.

The controller 21 calculates the moisture content of the sheet P on the basis of the ratio between the amount of received first near-infrared light and the amount of received second near-infrared light.

The configuration of the moisture content sensor 24 is not limited to the example illustrated in FIG. 3. The moisture content sensor 24 may have any other configuration as long as it can measure the characteristic information corresponding to the moisture content of the sheet P.

The sheet thickness sensor 23 and the moisture content sensor 24 can measure the respective pieces of characteristic information while moving the sheets to be conveyed at the conveyance speed.

The stiffness sensor 25 measures the characteristic information corresponding to the stiffness of the sheet and outputs the measurement result. The stiffness of the sheet is an index indicating the resistance when the sheet is bent.

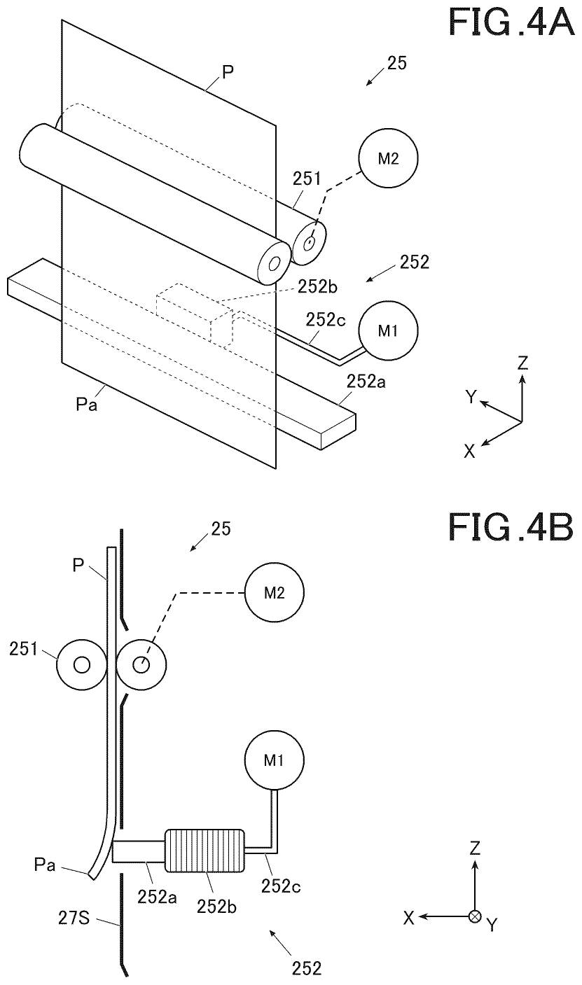

FIG. 4A is a perspective view illustrating a configuration of the stiffness sensor 25. FIG. 4B is a side view illustrating the configuration of the stiffness sensor 25.

The stiffness sensor 25 includes sheet holding rollers 251 that hold one end portion side of the sheet P, and a presser 252. In the examples illustrated in FIGS. 4A and 4B, the sheet holding rollers 251 are also included in the conveyor 27 and also have a function of conveying the sheet P, but a separate member may be applied.

The presser 252 includes a pressing member 252a, a pressing force detector 252b, a support mechanism 252c, and a motor M1.

The pressing member 252a is a member formed in an elongated shape in the sheet width direction (Y-axis direction) so as to be able to contact the entire width of the sheet P conveyed in the sheet conveyance direction (Z-axis direction). The pressing member 252a presses the sheet P.

The pressing force detector 252b includes, for example, a pressure sensor, and detects a pressing force from the sheet P when the pressing member 252a presses the sheet P.

The support mechanism 252c supports the pressing member 252a and the pressing force detector 252b so as to be movable in the X-axis direction.

The motor M1 is a driving source for moving the pressing member 252a and the pressing force detector 252b in the X-axis direction via the support mechanism 252c. The motor M1 includes, for example, a stepping motor.

A method of acquiring the stiffness of the sheet P will be described below.

As illustrated in FIGS. 4A and 4B, under the control of the controller 21, the conveyor 27 stops a motor M2 that drives the sheet holding rollers 251, and stops the conveyance of the sheet P at a predetermined position on the second conveyance path 27S. At this time, the sheet P is in a state of being nipped and held between the sheet holding rollers 251. The sheet holding rollers 251 hold the sheet P at a position separated from an end portion Pa of the sheet P by a predetermined distance.

Next, the presser 252 uses the drive of the motor MI to cause the pressing member 252a to move in the X-axis positive direction. Thus, as illustrated in FIG. 4B, the end portion Pa (free end) of the sheet P is pressed and bent by the pressing member 252a. At this time, a position at which the pressing member 252a starts to come into contact with the surface of the sheet P (the right side surface in FIG. 4B) in a state where the sheet P is not bent is set as a home position of the pressing member 252a in the X-axis direction. The pressing force that is received from the sheet P when the sheet P is bent by a predetermined amount (for example, 3 mm) by the pressing member 252a from the home position is detected by the pressing force detector 252b.

The presser 252 presses the pressing member 252a against the sheet P at a position closer to the end portion Pa of the sheet P than a position at which the sheet P is held by the sheet holding rollers 251, thereby pressing the sheet P. The amount of pressing and bending of the sheet P by the pressing member 252a can be grasped by the number of pulse signals input to the driver of the motor M1.

The stiffness sensor 25 outputs the pressing force that is detected by the pressing force detector 252b (characteristic information corresponding to the stiffness of the sheet) to the controller 21. The controller 21 calculates the stiffness of the sheet on the basis on the pressure value of the pressing force.

FIGS. 4A and 4B each illustrate an example in which the pressing member 252a presses the sheet P from the right to the left, but the present invention is not limited thereto. The pressing member 252a may press the sheet P in a direction from left to right.

The resistance sensor 26 measures the characteristic information corresponding to the electric resistance (volume electric resistance) of the sheet and outputs the measurement result.

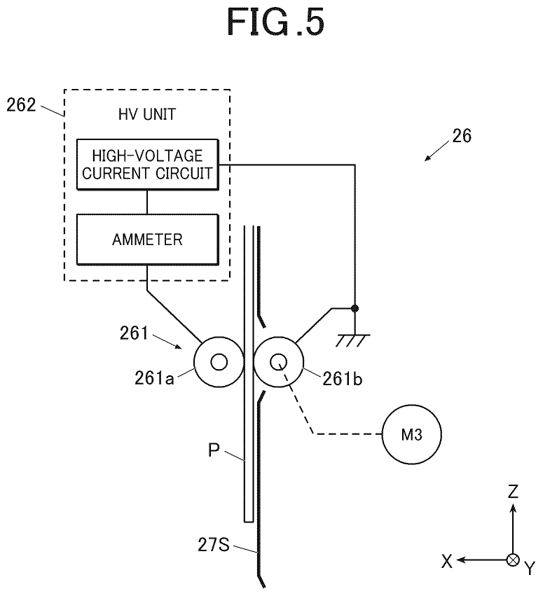

FIG. 5 is a schematic diagram illustrating a configuration of the resistance sensor 26.

As illustrated in FIG. 5, the resistance sensor 26 includes a sheet holding roller 261 that includes a pair of rollers for nipping the sheet P, and a high-voltage (HV) unit 262. In the example illustrated in FIG. 5, the sheet holding roller 261 is also included in the conveyor 27 and also have the function of conveying the sheet P, but a separate member may be applied.

The sheet holding roller 261 includes a detection roller 261a located on the left side of the drawing and an opposing roller 261b located on the right side of the drawing and grounded.

A method of acquiring the electric resistance of the sheet P will be described below.

As illustrated in FIG. 5, under the control of the controller 21, the conveyor 27 stops a motor M3 that drives the sheet holding roller 261, and temporarily stops the sheet P at a predetermined position on the second conveyance path 27S. At this time, the sheet P is in a state of being nipped and held by the sheet holding roller 261. In this state, the resistance sensor 26 applies a high voltage to the detection roller 261a with the HV unit 262 and measures the value of a current flowing through the opposing roller 261b via the sheet P. The resistance sensor 26 outputs the measured current value (characteristic information corresponding to the electric resistance of the sheet) to the controller 21. The controller 21 calculates the electric resistance of the sheet by dividing the voltage applied to the detection roller 261a by the HV unit 262 by the current value measured by the resistance sensor 26.

Alternatively, for one sheet, the characteristic information corresponding to the electric resistance of the sheet may be measured a plurality of times by the resistance sensor 26 to calculate the electric resistance of the sheet.

In this case, as described above, the resistance sensor 26 applies a high voltage to the detection roller 261a with the HV unit 262 and performs the first measurement of the value of the current flowing through the opposing roller 261b via the sheet P nipped by the sheet holding roller 261. Next, the resistance sensor 26 outputs the current value measured at the first time to the controller 21.

Next, under the control of the controller 21, the conveyor 27 conveys the sheet P so that the sheet P is held by the sheet holding roller 261 at a position other than the position where the sheet P has been held by the sheet holding roller 261 in the first measurement of the current value, and temporarily stops. In this state, the resistance sensor 26 applies a high voltage to the detection roller 261a with the HV unit 262, and performs the second measurement of the value of the current flowing to the opposing roller 261b via the sheet P nipped by the sheet holding roller 261. Next, the resistance sensor 26 outputs the current value measured at the second time to the controller 21. Hereinafter, similarly, the resistance sensor 26 measures the value of the current flowing through the opposing roller 261b via the sheet P a plurality of times.

Next, the controller 21 calculates the electric resistance of the sheet by dividing the voltage applied to the detection roller 261a by the HV unit 262 by an average value of the current values measured a plurality of times.

The stiffness sensor 25 and the resistance sensor 26 measure the respective pieces of characteristic information in a state where the conveyance of the sheet is temporarily stopped.

Under the control of the controller 21, the conveyor 27 ejects the sheet for which the measurement by each sensor has been completed to the purge tray 271 without conveying the sheet to the image forming apparatus 3.

In the image forming system U, the communicator 28 controls communication between the sheet characteristic detection apparatus 2 and the sheet feed apparatus 1, the image forming apparatus 3, and the post-processing apparatus 4.

The controller 21 outputs at least one of the sheet thickness, the moisture content, the stiffness, and the electric resistance of the sheet as the characteristics of the sheet to the image forming apparatus 3 via the communicator 28.

### Image Forming Apparatus

The image forming apparatus 3, for example, forms the image of image data read from a document on a sheet and outputs the image. The image forming apparatus 3 forms the image on the sheet by an electrophotographic method on the basis of the image data received from an external device (not illustrated), and outputs the sheet. That is, the image forming apparatus 3 is a multifunction peripheral. The image forming apparatus 3 may be connected to an external device, for example, a PC via a local area network (LAN) or the like.

The image forming apparatus 3 includes a controller 301, a document reader 302, an operation acceptor 303, a display 304, an image former 305, a storage (not illustrated), a communicator (not illustrated), and the like.

The controller 301 integrally controls the operation of the image forming apparatus 3. The controller 301 includes a CPU, a RAM, and the like. The CPU performs various settings and operations related to image formation according to an operation signal input from the operation acceptor 303 or an instruction signal received by the communicator.

The document reader 302 reads the image of the document placed on a document plate or an auto document feeder (ADF). The document reader 302 scans and exposes the document by an optical system of a scanning exposure device, and reads its reflected light by a line image sensor to obtain an image signal. Next, the image reader 302 performs processing such as A/D conversion, shading correction, and compression on the image signal to generate image data.

The operation acceptor 303 accepts an input operation from the outside by a user or the like. The operation acceptor 303 includes a touch screen provided on a screen of the display 304, and various hard keys arranged around the screen of the display 304. The operation acceptor 303 converts the accepted operation content into an operation signal corresponding to the content and outputs the operation signal to the controller 301. The touch screen may be of, for example, any one of a pressure-sensitive type, an electrostatic type, an optical type, and the like.

The display 304 includes, for example, a color liquid crystal display, and displays various kinds of information on the basis of the control of the controller 301.

The image former 305 applies and fixes a color material to the sheet on the basis of the image data to be formed.

The controller 301 determines image forming conditions in the image former 305 on the basis of at least any one of the sheet thickness, the moisture content, the stiffness, and the electric resistance of the sheet received from the sheet characteristic detection apparatus 2. The image former 305 forms an image on the sheet on the basis of the image forming conditions.

The image former 305 includes four writers 31, an intermediate transfer belt 32, a secondary transfer roller 33, a fixer 34, and the like.

The four writers 31 are arranged in series (tandem) along the belt surface of the intermediate transfer belt 32, and form images of respective colors of cyan (C), magenta (M), yellow (Y), and black (K). The writers 31 may have the same configuration among the colors. For example, the writer 31 includes an optical scanner 31a, a photoreceptor 31b, a developer 31c, a charger 31d, a cleaner 31e, and a primary transfer roller 31f.

In each of the writers 31, the charger 31d uniformly charges the photoreceptor 31b. The optical scanner 31a emits a light beam on the basis of the original image data to scan and expose the charged photoreceptor 31b, thereby forming an electrostatic latent image. The developer 31c supplies a color material such as toner to the electrostatic latent image to develop the image, thereby forming the image on the photoreceptor 31b.

The four writers 31 sequentially transfer the respective images formed on the photoreceptors 31b onto the intermediate transfer belt 32 in a superimposed manner by the respective primary transfer rollers 31f. The writer 31 forms an image of each color on the intermediate transfer belt 32 by the transfer (primary transfer). The intermediate transfer belt 32 circulates while being wound around a plurality of rollers. After the primary transfer, the cleaner 31e removes the coloring material remaining on the photoreceptor 31b.

The image forming apparatus 3 causes the sheet to pass through the position of the secondary transfer roller 33 in accordance with timing at which the image on the circulating intermediate transfer belt 32 reaches the position of the secondary transfer roller 33. The secondary transfer roller 33 includes a pair of rollers. One of the rollers is pressed against and contacts the intermediate transfer belt 32, and the other of the rollers serves as one of a plurality of rollers around which the intermediate transfer belt 32 is wound. The image is transferred (secondary transfer) onto the sheet from the intermediate transfer belt 32 pressed and contacted by the secondary transfer roller 33.

The sheet on which the image has been secondarily transferred is conveyed to the fixer 34 and is subjected to a fixing process. The fixer 34 includes a pair of fixing rollers that are in press-contact with each other and at least one of which is heatable. The fixing rollers fix the image onto the sheet by applying heat and pressure to the sheet passing between the fixing rollers.

In a case where images are formed on both sides of a sheet, the sheet having an image formed and fixed on one side is sent to a reverse path 36 and turned over. Thereafter, the sheet is returned to a position on the upstream side of the secondary transfer roller 33. In a case where the image formation is performed on only one side or in a case where the image formation on both sides is completed, the sheet is ejected from the fixer 34 to the post-processing apparatus 4.

### Post-Processing Apparatus

The post-processing apparatus 4 performs a post process on the sheet on which the image has been formed. The post process includes, for example, sorting, cutting, stapling, folding, and the like. The post-processing apparatus 4 ejects the post-processed sheet to an ejection tray E or the like.

### 2. Operation of Image Forming System

Next, operation of the image forming system U will be described.

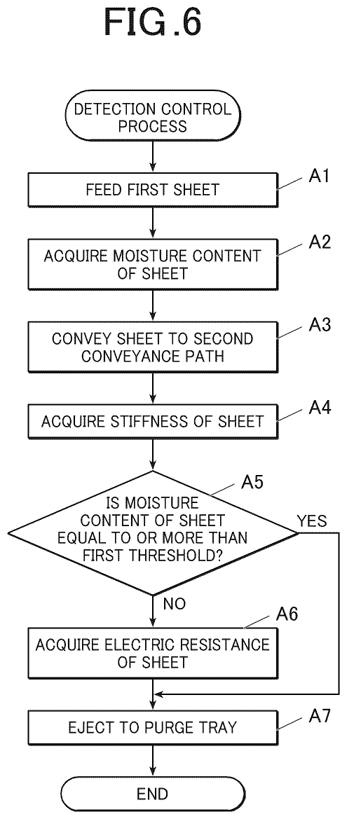

FIG. 6 is a flowchart illustrating a control procedure for a detection control process to be executed by the controller 21 of the sheet characteristic detection apparatus 2. The controller 21 executes the detection control process before start of the image forming operation.

In the present embodiment, the first characteristic of the sheet is the moisture content of the sheet, and the moisture content sensor 24 functions as a first characteristic detector. The second characteristic of the sheet is the electric resistance of the sheet, and the resistance sensor 26 functions as a second characteristic detector.

The controller 21 controls the second characteristic detector on the basis of the detection result of the first characteristic detector in the detection control process.

### Detection Control Process

The controller 21 causes the sheet feed apparatus 1 to feed a first sheet from the tray that supplies sheets on which images are to be formed, and conveys the first sheet along the first conveyance path 27M (step A1).

Next, the controller 21 acquires the characteristic information (first characteristic information) corresponding to the moisture content of the sheet from the moisture content sensor 24 of the sheet characteristic detection apparatus 2. Next, the controller 21 calculates the moisture content of the sheet on the basis of the characteristic information, thereby acquiring the moisture content of the sheet (step A2).

Next, the controller 21 conveys the sheet to the second conveyance path 27S (step A3).

Next, the controller 21 acquires the characteristic information corresponding to the stiffness of the sheet from the stiffness sensor 25. The controller 21 calculates the stiffness of the sheet on the basis of the characteristic information, thereby acquiring the stiffness of the sheet (step A4).

Next, the controller 21 determines whether the moisture content of the sheet acquired in step A2 is equal to or more than a predetermined first threshold (for example, 30%) (step A5). The first threshold is set in advance.

If the moisture content of the sheet is less than the first threshold (step A5; NO), the controller 21 acquires the characteristic information (second characteristic information) corresponding to the electric resistance of the sheet by the resistance sensor 26. The controller 21 calculates the electric resistance of the sheet on the basis of the characteristic information, thereby acquiring the electric resistance of the sheet (step A6).

Next, the controller 21 conveys the sheet along the second conveyance path 27S, ejects the sheet to the purge tray 271 (step A7), and ends the detection control process.

On the other hand, if the moisture content of the sheet is equal to or more than the first threshold (step A5; YES), the controller 21 shifts the detection control process to step A7.

That is, if the moisture content of the sheet is equal to or more than the first threshold, the controller 21 ejects the sheet without causing the resistance sensor 26 to perform measurement. In other words, the controller 21 controls not to perform the detection by the resistance sensor 26 (second characteristic detector) according to the detection result of the moisture content sensor 24 (first characteristic detector). In this case, the controller 21 ejects the sheet without causing the resistance sensor 26 (second characteristic detector) to perform the operation of stopping the sheet.

Thus, if the moisture content of the sheet is equal to or more than the first threshold, a high voltage is not applied to the sheet by the resistance sensor 26, thereby preventing an electric device in the sheet characteristic detection apparatus 2 from being damaged due to the leakage voltage applied to the electric device via the sheet.

### 3. Modification Examples

Although the present embodiment has been described above, the specific configuration is not limited to the above-described present embodiment and can be changed without departing from the scope of the invention. Hereinafter, modification examples of the present embodiment will be described. In the modification examples, components similar to those of the above-described embodiment are denoted by the same reference numerals, and description thereof will be omitted.

### Modification Example 1

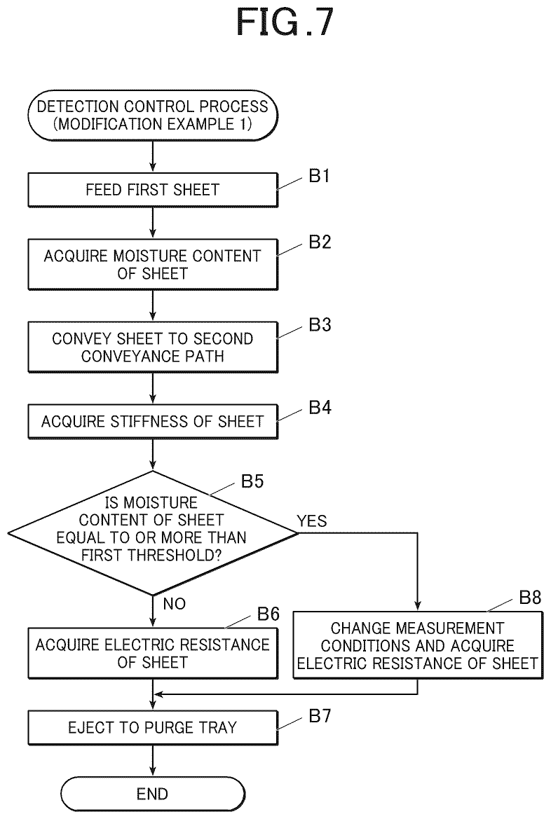

FIG. 7 illustrates a flowchart of a detection control process of modification example 1.

In modification example 1, the first characteristic of the sheet is the moisture content of the sheet, and the moisture content sensor 24 functions as the first characteristic detector. The second characteristic of the sheet is the electric resistance of the sheet, and the resistance sensor 26 functions as a second characteristic detector.

In the detection control process of modification example 1, the controller 21 controls the second characteristic detector on the basis of the detection result of the first characteristic detector.

### Detection Control Process of Modification Example 1

The controller 21 executes steps B1 to B7 similar to steps A1 to A7 of the above-described embodiment.

If the moisture content of the sheet is equal to or more than the first threshold (step B5; YES), the controller 21 changes the measurement conditions of the characteristic information (second characteristic information) corresponding to the electric resistance of the sheet in the resistance sensor 26. That is, the controller 21 changes the detection conditions in the resistance sensor 26 (second characteristic detector) according to the detection result of the moisture content sensor 24 (first characteristic detector). Next, the controller 21 acquires, from the resistance sensor 26, the characteristic information corresponding to the electric resistance of the sheet measured under the changed measurement conditions. Next, the controller 21 acquires the electric resistance of the sheet by calculating the electric resistance of the sheet on the basis of the characteristic information (step B8), and shifts the detection control process to step B7.

In step B8, as the change of the measurement conditions, for example, the controller 21 decreases the voltage to be applied to the detection roller 261a by the HV unit 262 from 2000 V to 1000 V.

### Modification Example 2

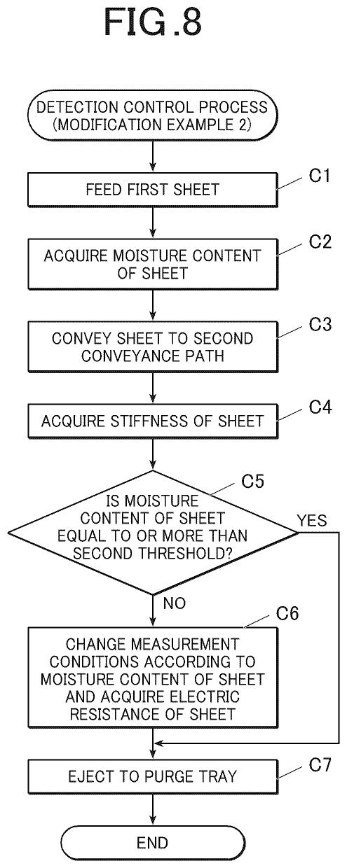

FIG. 8 illustrates a flowchart of a detection control process of modification example 2.

In modification example 2, the first characteristic of the sheet is the moisture content of the sheet, and the moisture content sensor 24 functions as the first characteristic detector. The second characteristic of the sheet is the electric resistance of the sheet, and the resistance sensor 26 functions as a second characteristic detector.

In the detection control process of modification example 2, the controller 21 controls the second characteristic detector on the basis of the detection result of the first characteristic detector.

### Detection Control Process of Modification Example 2

The controller 21 executes steps C1 to C4 similar to steps A1 to A4 of the above-described embodiment.

Next, the controller 21 determines whether the moisture content of the sheet acquired in step C2 is equal to or more than a predetermined second threshold (for example, 50%) (step C5). The second threshold is set in advance.

If the moisture content of the sheet is less than the second threshold (step C5; NO), the controller 21 changes the measurement conditions of the characteristic information (second characteristic information) corresponding to the electric resistance of the sheet in the resistance sensor 26 according to the moisture content of the sheet acquired in step C2. Next, the controller 21 acquires, from the resistance sensor 26, the characteristic information corresponding to the electric resistance of the sheet measured under the changed measurement conditions. Next, the controller 21 calculates the electric resistance of the sheet on the basis of the characteristic information, thereby acquiring the electric resistance of the sheet (step C6).

In step C6, as the change in the measurement conditions, the controller 21 decreases the voltage to be applied to the detection roller 261a by the HV unit 262 as the moisture content of the sheet increases. That is, the controller 21 decreases the voltage to be applied to the sheet when detecting the characteristic information corresponding to the electric resistance with the resistance sensor 26 (second characteristic detector) as the moisture content (amount of moisture) of the sheet increases.

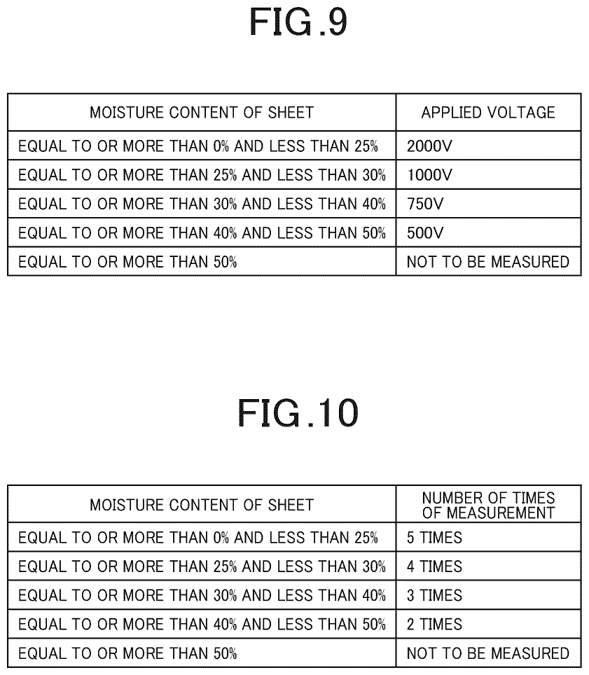

FIG. 9 illustrates a correspondence between the moisture content of the sheet and the voltage (applied voltage) applied to the detection roller 261a by the HV unit 262.

Alternatively, in step C6, the resistance sensor 26 may measure the characteristic information corresponding to the electric resistance of the sheet a plurality of times for one sheet. In this case, as the change of the measurement conditions, the controller 21 decreases the number of times of measurement by the resistance sensor 26 for one sheet as the moisture content of the sheet increases. That is, the controller 21 decreases the number of times of detection of the characteristic information corresponding to the electric resistance with the resistance sensor 26 (second characteristic detector) as the moisture content (amount of moisture) of the sheet increases.

FIG. 10 illustrates a correspondence between the moisture content of the sheet and the number of times of measurement with the resistance sensor 26 for one sheet.

Next, the controller 21 conveys the sheet along the second conveyance path 27S, ejects the sheet to the purge tray 271 (step C7), and ends the detection control process.

On the other hand, if the moisture content of the sheet is equal to or more than the second threshold (step C5; YES), the controller 21 shifts the detection control process to step C7.

That is, if the moisture content of the sheet is equal to or more than the second threshold, the controller 21 ejects the sheet without causing the resistance sensor 26 to perform measurement.

### Modification Example 3

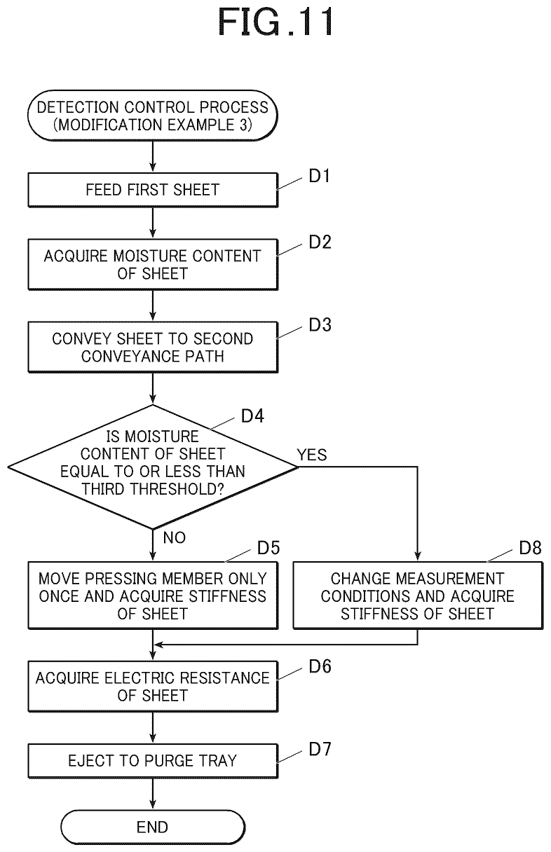

FIG. 11 illustrates a flowchart of a detection control process of modification example 3.

In modification example 3, the first characteristic of the sheet is the moisture content of the sheet, and the moisture content sensor 24 functions as the first characteristic detector. The second characteristic of the sheet is the stiffness of the sheet, and the stiffness sensor 25 functions as a second characteristic detector.

In the detection control process of modification example 3, the controller 21 controls the second characteristic detector on the basis of the detection result of the first characteristic detector.

### Detection Control Process of Modification Example 3

The controller 21 executes steps D1 to D3 similar to steps A1 to A3 of the above-described embodiment. Next, the controller 21 determines whether the moisture content of the sheet acquired in step D2 is equal to or less than a predetermined third threshold (for example, 3%) (step D4). The third threshold value is set in advance.

If the moisture content of the sheet is more than the third threshold (step D4; NO), the controller 21 acquires the characteristic information (second characteristic information) corresponding to the stiffness of the sheet from the stiffness sensor 25. The controller 21 calculates the stiffness of the sheet on the basis of the characteristic information, thereby acquiring the stiffness of the sheet (step D5).

In step D5, the presser 252 uses the drive of the motor Ml to cause the pressing member 252a to move only once in the X-axis positive direction. The pressing force detector 252b detects the pressing force received from the sheet P at this time.

Next, the controller 21 executes steps D6 and D7 similar to steps A6 and A7 of the above-described embodiment.

On the other hand, if the moisture content of the sheet is equal to or less than the third threshold (step D4; YES), the controller 21 changes the measurement conditions of the characteristic information corresponding to the stiffness of the sheet in the stiffness sensor 25. Next, the controller 21 acquires, from the stiffness sensor 25, the characteristic information corresponding to the stiffness of the sheet measured under the changed measurement conditions. Next, the controller 21 acquires the stiffness of the sheet by calculating the stiffness of the sheet on the basis of the characteristic information (step D8), and shifts the detection control process to step D6.

In step D8, the controller 21 moves the pressing member 252a twice in the X-axis positive direction as a change in the measurement conditions, and measures the pressing force received from the sheet P after the second movement with the pressing force detector 252b.

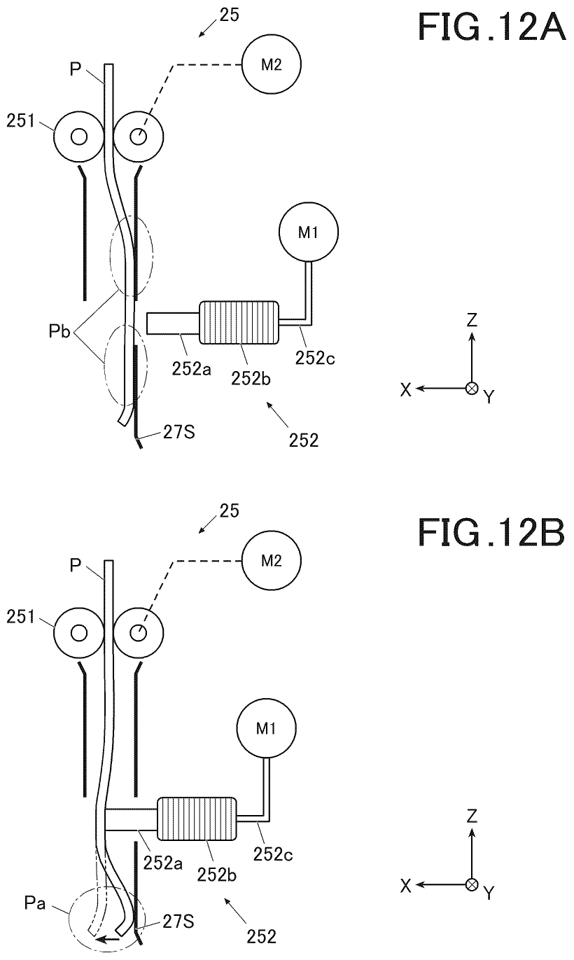

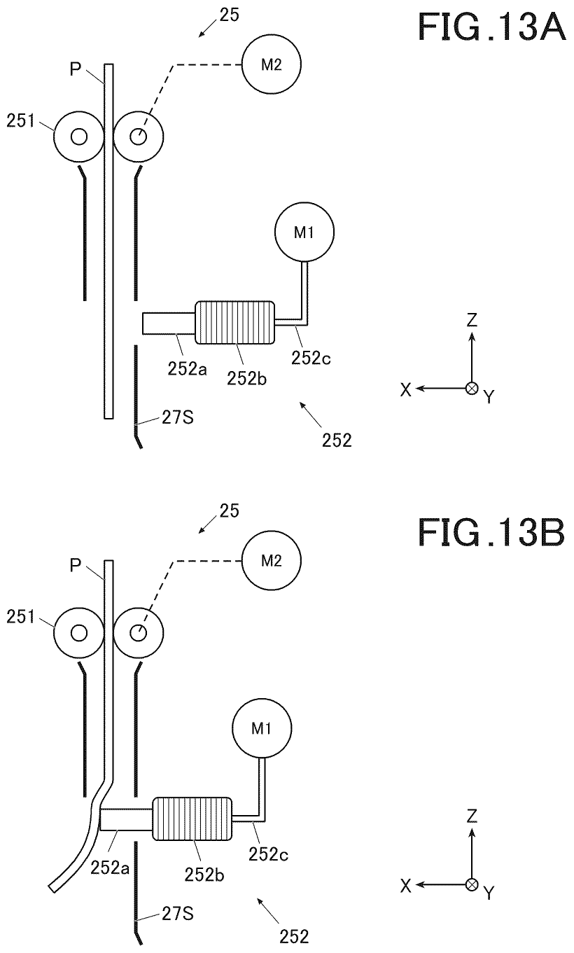

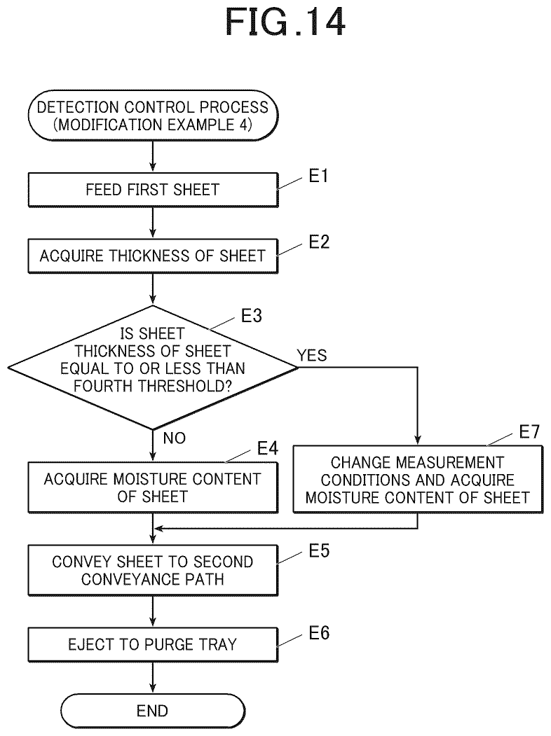

FIGS. 12A to 13B each illustrate an example in which the characteristic information corresponding to the stiffness of the sheet is measured by the stiffness sensor 25 when the moisture content of the sheet is equal to or less than the third threshold.

FIG. 12A illustrates a schematic diagram of the sheet P and the stiffness sensor 25 before the first movement of the pressing member 252a in the X-axis positive direction.

If the moisture content of the sheet is equal to or less than the third threshold, the sheet P is charged by friction between the sheet P and the conveyance rollers during conveyance of the sheet P to the stiffness sensor 25. Therefore, as illustrated in FIG. 12A, when the sheet P is held by the sheet holding roller 251, predetermined portions Pb of the sheet P adhere to the second conveyance path 27S.

FIG. 12B illustrates a state where, in this state, the pressing member 252a is moved in the X-axis positive direction and the sheet P is pressed by the pressing member 252a.

In this case, since the end portion Pa of the sheet P moves in a direction of an arrow indicated in FIG. 12B, the pressing force detector 252b cannot accurately measure the pressing force received from the sheet P.

Thereafter, the stiffness sensor 25 returns the pressing member 252a to the original position.

As illustrated in FIG. 12B, the electric charge of the sheet P is removed by the pressing member 252a contacting the sheet P. Therefore, as illustrated in FIG. 13A, before the second movement of the pressing member 252a in the X-axis positive direction, the sheet P is not adhering to the second conveyance path 27S.

Therefore, as illustrated in FIG. 13B, after the second movement of the pressing member 252a, the pressing force detector 252b can accurately measure the pressing force received from the sheet P.

As described above, in step D8, the controller 21 changes the detection operation at the time of detecting the characteristic information corresponding to the stiffness with the stiffness sensor 25 (second characteristic detector) according to the moisture content (amount of moisture) of the sheet.

### Modification Example 4

FIG. 15 illustrates a flowchart of a detection control process of modification example 4.

In modification example 4, the first characteristic of the sheet is the sheet thickness of the sheet, and the sheet thickness sensor 23 functions as a first characteristic detector. The second characteristic of the sheet is the moisture content of the sheet, and the moisture content sensor 24 functions as a second characteristic detector.

In the detection control process of modification example 4, the controller 21 controls the second characteristic detector on the basis of the detection result of the first characteristic detector.

### Detection Control Process of Modification Example 4

The controller 21 executes step E1 similar to step Al of the above-described embodiment.

Next, the controller 21 acquires the sheet thickness (first characteristic information) of the sheet from the sheet thickness sensor 23 (step E2).

Next, the controller 21 determines whether the sheet thickness of the sheet acquired in step E2 is equal to or less than a fourth predetermined threshold (step E3). The fourth threshold is set in advance.

When the sheet thickness of the sheet is more than the fourth threshold (step E3; NO), the controller 21 executes steps E2 to E6 similar to steps A2, A3, and A7 of the above-described embodiment, and ends the detection control process. In this case, after step E5, the controller 21 may execute the same processes as steps A5 and A6 of the above-described embodiment.

On the other hand, if the sheet thickness of the sheet is equal to or less than the fourth threshold (step E3; YES), the controller 21 changes the measurement conditions of the characteristic information (second characteristic information) corresponding to the moisture content of the sheet in the moisture content sensor 24. Next, the controller 21 acquires, from the moisture content sensor 24, the characteristic information corresponding to the moisture content of the sheet measured under the changed measurement conditions. Next, the controller 21 acquires the moisture content of the sheet by calculating the moisture content of the sheet on the basis of the characteristic information (step E7), and shifts the detection control process to step E5.

If the sheet thickness of the sheet is equal to or less than the fourth threshold, the sheet is likely to vibrate in the up-down direction (the Z-axis direction illustrated in FIG. 1). In order to accurately measure the characteristic information corresponding to the moisture content of the sheet, it is necessary to perform the measurement at the timing when the vibration ends.

Therefore, in step E7, the controller 21 controls the moisture content sensor 24 so that the timing of measuring the characteristic information corresponding to the moisture content of the sheet is later than the case where the sheet thickness of the sheet is more than the fourth threshold, as the change of the measurement conditions. That is, the controller 21 changes, according to the sheet thickness of the sheet, the detection conditions for detecting the characteristic information corresponding to the moisture content (amount of moisture) of the sheet by the moisture content sensor 24 (second characteristic detector).

### Others

In the image forming system U according to each of the above-described embodiment and modification examples, the sheet characteristic detection apparatus 2 is arranged upstream of the image forming apparatus 3, but the present invention is not limited thereto. The sheet characteristic detection apparatus 2 may be arranged downstream of the image forming apparatus 3.

Also in this case, the controller 301 of the image forming apparatus 3 determines the image forming conditions on the basis of at least one of the sheet thickness, the moisture content, the stiffness, and the electric resistance of the sheet received from the sheet characteristic detection apparatus 2.

In the detection control process according to each of the above-described embodiment and modification examples, the controller 21 controls the second characteristic detector on the basis of the detection result of the first characteristic detector, but the present invention is not limited thereto. The controller 21 may control the first characteristic detector on the basis of the detection result of the second characteristic detector.

### 4. Effect

As described above, the sheet characteristic detection apparatus 2 of the present embodiment includes the first characteristic detector that is arranged on the conveyance path of the sheet and detects the first characteristic information corresponding to the first characteristic of the sheet.

The sheet characteristic detection apparatus 2 of the present embodiment includes the second characteristic detector that is arranged on the conveyance path of the sheet and detects the second characteristic information corresponding to the second characteristic of the sheet.

In the sheet characteristic detection apparatus 2 of the present embodiment, on the basis of the detection result of any one of the first characteristic detector and the second characteristic detector, the other characteristic detector is controlled.

Therefore, when the moisture content of the sheet is equal to or more than the predetermined value, it is possible not to perform the measurement with the resistance sensor 26 or to decrease the voltage to be applied to the sheet in the resistance sensor 26. As a result, it is possible to prevent a failure of the device due to a leakage voltage generated when the electric resistance of the sheet is detected. That is, it is possible to prevent a problem that occurs depending on the characteristics of the sheet when the characteristics of the sheet are measured.

The sheet characteristic detection apparatus 2 of the present embodiment is arranged on the upstream side or the downstream side of the image former 305 that forms an image on a sheet.

Therefore, in both of the configuration in which the sheet characteristic detection apparatus 2 is arranged on the upstream side of the image forming apparatus 3 and the configuration in which the sheet characteristic detection apparatus 2 is arranged on the downstream side of the image forming apparatus 3, it is possible to prevent a failure of the device due to a leakage voltage generated when the electric resistance of the sheet is detected.

The sheet characteristic detection apparatus 2 of the present embodiment is arranged on the upstream side of the image former 305.

The image forming conditions in the image former 305 are determined on the basis of at least one of the first characteristic information and the second characteristic information.

Therefore, it is possible to form a high-quality image by stably conveying the sheet under the image forming conditions corresponding to the characteristics of the sheet.

In the sheet characteristic detection apparatus 2 of the present embodiment, the second characteristic detector is arranged on the downstream side of the first characteristic detector.

In the sheet characteristic detection apparatus 2 of the present embodiment, the second characteristic detector is controlled according to the detection result of the first characteristic detector.

In the sheet characteristic detection apparatus 2 of the present embodiment, the detection conditions in the second characteristic detector are changed according to the detection result of the first characteristic detector.

Therefore, when the moisture content of the sheet is equal to or more than the predetermined value, the voltage to be applied to the sheet in the resistance sensor 26 can be decreased. As a result, it is possible to prevent a failure of the device due to a leakage voltage generated when the electric resistance of the sheet is detected.

In the sheet characteristic detection apparatus 2 of the present embodiment, the second characteristic detector (resistance sensor 26) is controlled not to perform detection according to the detection result of the first characteristic detector.

Therefore, when the moisture content of the sheet is equal to or more than a predetermined value, it is possible to perform control so that the measurement with the resistance sensor 26 is not performed. As a result, it is possible to prevent a failure of the device due to a leakage voltage generated when the electric resistance of the sheet is detected.

In the sheet characteristic detection apparatus 2 of the present embodiment, when the detection with the second characteristic detector is not performed, the sheet is ejected without causing the second characteristic detector to perform the operation of stopping the sheet.

In the sheet characteristic detection apparatus 2 of the present embodiment, the first characteristic and the second characteristic are different from each other.

In the sheet characteristic detection apparatus 2 of the present embodiment, the first characteristic information is information corresponding to the moisture content of the sheet, and the second characteristic information is information corresponding to the electric resistance of the sheet.

In the sheet characteristic detection apparatus 2 of the present embodiment, the voltage to be applied to the sheet when information corresponding to the electric resistance is detected by the second characteristic detector (resistance sensor 26) is decreased as the moisture amount (moisture content) of the sheet increases.

Therefore, it is possible to prevent a failure of the device due to a leakage voltage generated when the electric resistance of the sheet is detected.

In the sheet characteristic detection apparatus 2 of the present embodiment, the number of times of detection of the information corresponding to the electric resistance with the second characteristic detector is decreased as the moisture amount (moisture content) of the sheet is increased.

Therefore, it is possible to prevent a failure of the device due to a leakage voltage generated when the electric resistance of the sheet is detected.

In the sheet characteristic detection apparatus 2 of the present embodiment, the second characteristic detector is arranged on the downstream side of the first characteristic detector.

In the sheet characteristic detection apparatus 2 of the present embodiment, the first characteristic information is information corresponding to the moisture content of the sheet, and the second characteristic information is information corresponding to the stiffness of the sheet.

In the sheet characteristic detection apparatus 2 of the present embodiment, the detection operation at the time of detecting the information corresponding to the stiffness with the second characteristic detector (stiffness sensor 25) is changed according to the moisture amount (moisture content) of the sheet.

Therefore, even in a case where the moisture content of the sheet is equal to or less than a predetermined value and the sheet is electrically charged and adheres to the second conveyance path 27S, the stiffness of the sheet can be accurately detected.

In the sheet characteristic detection apparatus 2 of the present embodiment, the second characteristic detector is arranged on the downstream side of the first characteristic detector.

In the sheet characteristic detection apparatus 2 of the present embodiment, the first characteristic information is information corresponding to the sheet thickness of the sheet, and the second characteristic information is information corresponding to the moisture amount (moisture content) of the sheet.

In the sheet characteristic detection apparatus 2 of the present embodiment, the detection conditions when the information corresponding to the moisture content of the sheet is detected by the second characteristic detector (moisture content sensor 24) are changed according to the sheet thickness of the sheet.

Therefore, even in a case where the sheet thickness of the sheet is equal to or less than a predetermined value and the sheet is likely to vibrate, the moisture content of the sheet can be accurately detected.

The sheet characteristic detection apparatus 2 of the present embodiment includes a controller 21 that controls, on the basis of the detection result of any one of the first characteristic detector and the second characteristic detector, the other characteristic detector.

The present invention is not limited to the above-described embodiment, and various modifications are possible.

For example, in the above-described embodiment, the controller 21 of the sheet characteristic detection apparatus 2 controls, on the basis of the detection result of any one of the first characteristic detector and the second characteristic detector, the other characteristic detector, but the present invention is not limited thereto. The controller 301 of the image forming apparatus 3 may control, on the basis of the detection result of any one of the first characteristic detector and the second characteristic detector, the other characteristic detector.

Although the controller 301 of the image forming apparatus 3 acquires at least one of the sheet thickness, the moisture content, the stiffness, and the electric resistance of the sheet from the sheet characteristic detection apparatus 2 to determine the image forming conditions of the image former 305 in the above-described embodiment, the present invention is not limited thereto. The controller 21 of the sheet characteristic detection apparatus 2 may perform a process of determining the image forming conditions of the image former 305. Alternatively, the image forming system U may have a control unit for determining the image forming conditions of the image former 305, separately from the controller 301 of the image forming apparatus 3.

In the image forming system U described above, the sheet characteristic detection apparatus 2 is independently located between the sheet feed apparatus 1 and the image forming apparatus 3, but the present invention is not limited thereto. The sheet feed apparatus 1 or the image forming apparatus 3 may include the sheet thickness sensor 23, the moisture content sensor 24, the stiffness sensor 25, and the resistance sensor 26.

In the above description, the storage 22 including a non-volatile memory such as an HDD or a flash memory has been described as an example of a computer-readable medium that stores a program related to the setting control of the present invention, but the present invention is not limited thereto. As other computer-readable media, other non-volatile memories such as an MRAM and portable recording media such as a CD-ROM and a DVD disk can be applied. As a medium for providing data of the program according to the present invention via a communication line, a carrier wave is also applied to the present invention.

In addition, the specific configurations, the contents and procedures of the processing operations, and the like described in the above embodiment can be appropriately changed without departing from the spirit and scope of the present invention. It is intended that the scope of the present invention includes the scope of the invention described in the scope of the claims and the scope of equivalents thereof.

Although embodiments of the present invention have been described and shown in detail, the disclosed embodiments are made for purposes of illustration and example only and not limitation. The scope of the present invention should be interpreted by terms of the appended claims.

What is claimed is:

1. A sheet characteristic detection apparatus, comprising:
a first characteristic detector that is arranged on a conveyance path of a sheet and detects first characteristic information corresponding to a first characteristic of the sheet; and
a second characteristic detector that is arranged on the conveyance path and detects second characteristic information corresponding to a second characteristic of the sheet,
wherein, on a basis of a detection result of any one of the first characteristic detector and the second characteristic detector, the other characteristic detector is controlled.

2. The sheet characteristic detection apparatus according to claim 1, wherein the sheet characteristic detection apparatus is arranged on an upstream side or a downstream side of an image former that forms an image on the sheet.

3. The sheet characteristic detection apparatus according to claim 2, wherein
the sheet characteristic detection apparatus is arranged on the upstream side of the image former, and
image forming conditions in the image former are determined on a basis of at least any one of the first characteristic information and the second characteristic information.

4. The sheet characteristic detection apparatus according to claim 1, wherein
the second characteristic detector is arranged on a downstream side of the first characteristic detector, and
the second characteristic detector is controlled according to a detection result of the first characteristic detector.

5. The sheet characteristic detection apparatus according to claim 4, wherein detection conditions in the second characteristic detector are changed according to a detection result of the first characteristic detector.

6. The sheet characteristic detection apparatus according to claim 4, wherein the second characteristic detector is controlled not to perform detection according to a detection result of the first characteristic detector.

7. The sheet characteristic detection apparatus according to claim 6, wherein in a case where the second characteristic detector does not perform the detection, the sheet is ejected without causing the second characteristic detector to perform an operation of stopping the sheet.

8. The sheet characteristic detection apparatus according to claim 1, wherein the first characteristic and the second characteristic are different from each other.

9. The sheet characteristic detection apparatus according to claim 1, wherein
the first characteristic information is information corresponding to a moisture amount of the sheet, and
the second characteristic information is information corresponding to an electric resistance of the sheet.

10. The sheet characteristic detection apparatus according to claim 9, wherein a voltage to be applied to the sheet when the second characteristic detector detects the information corresponding to the electric resistance is decreased as the moisture amount is increased.

11. The sheet characteristic detection apparatus according to claim 9, wherein the number of times of detection of the information corresponding to the electric resistance with the second characteristic detector is decreased as the moisture amount is increased.

12. The sheet characteristic detection apparatus according to claim 1, wherein
the second characteristic detector is arranged on a downstream side of the first characteristic detector,
the first characteristic information is information corresponding to a moisture amount of the sheet, and
the second characteristic information is information corresponding to stiffness of the sheet.

13. The sheet characteristic detection apparatus according to claim 12, wherein a detection operation performed when the information corresponding to the stiffness is detected by the second characteristic detector is changed according to the moisture amount.

14. The sheet characteristic detection apparatus according to claim 1, wherein
the second characteristic detector is arranged on a downstream side of the first characteristic detector,
the first characteristic information is information corresponding to a sheet thickness of the sheet, and
the second characteristic information is information corresponding to a moisture amount of the sheet.

15. The sheet characteristic detection apparatus according to claim 14, wherein detection conditions when the second characteristic detector detects the information corresponding to the moisture amount are changed according to the sheet thickness.

16. The sheet characteristic detection apparatus according to claim 1, further comprising a hardware processor that controls, on a basis of a detection result of any one of the first characteristic detector and the second characteristic detector, the other characteristic detector.

17. An image forming system, comprising:
the sheet characteristic detection apparatus according to claim 1; and
an image former that forms an image on the sheet.

18. A non-transitory recording medium storing a computer readable program for a computer of a sheet characteristic detection apparatus comprising:
a first characteristic detector that is arranged on a conveyance path of a sheet and detects first characteristic information corresponding to a first characteristic of the sheet; and
a second characteristic detector that is arranged on the conveyance path and detects second characteristic information corresponding to a second characteristic of the sheet,
the program causing a computer to perform:
controlling, on a basis of a detection result of any one of the first characteristic detector and the second characteristic detector, the other characteristic detector.
